(19) United States
(12) Patent Application Publication
(10) Pub. No.: US 2006/0282386 A1
(43) Pub. Date: Dec. 14, 2006

(54) Method and system for premium access

(76) Inventors: Christopher T. Szeto, Sunnyvale, CA (US); Chen Zhang, Monte Sereno, CA (US); Thyagarajapuram Ramakrishnan, Saratoga, CA (US); Rajanikanth Vemulapalli, San Jose, CA (US)

Correspondence Address: MORRISON & FOERSTER LLP, 755 PAGE MILL RD, PALO ALTO, CA, 94304-1018, US

(21) Appl. No.: 11/375,802

(22) Filed: Mar. 14, 2006

Related U.S. Application Data
(60) Provisional application No. 60/661,544, filed on Mar. 14, 2005.

(51) Int. Cl. G06Q 99/00

(52) U.S. Cl. 705/50

(57) ABSTRACT

A method for instant messaging, comprising: receiving a login request containing information associated with a user; determining, based on the information, whether that user is authorized to use at least one premium service for instant messaging; causing display of a premium instant messaging user interface enabling use of the premium service on a client computer in response to the user is authorized to use the premium service; and causing the same client computer to display a second instant messaging user interface in response to the user is not authorized to use the premium service for instant messaging.

### CROSS-REFERENCE TO RELATED APPLICATIONS

This application claims the benefit of application Ser. No. 60/661,544, entitled “Method and System for Premium Access” filed Mar. 14, 2005, which is incorporated herein in its entirety by reference.

### FIELD OF THE INVENTION

The present invention relates to computer networks generally, and more specifically to instant messaging systems.

### BACKGROUND

Instant messaging systems have grown in popularity in recent years. Instant messaging (IM) systems allow two users to exchange electronic communications in real time in a private session, with simplified entry of messages. The dialog between two users is displayed in a single window that both users can view. Instant messaging provides a more immediate and intimate means of communication than e-mail. An example of a popular instant messaging system is Yahoo! Messenger, provided by Yahoo! Inc. of Sunnyvale, Calif.

Typically, IM systems allow a user to form one or more lists of people with whom he or she wishes to communicate. This list may be called a “friends list.” Typically, a portion of the IM interface displays the user's personal friends list, and provides an indication of whether each person on the friends list is online at any given time. The user who wishes to initiate a conversation can then determine who is available to receive real time messages. The interface may also allow each user to post a status indicator to tell the user's friends that the user is “out to lunch”, or unavailable for another reason or time period. The sender can attach file to the message.

From their beginnings as text based messaging systems, IM facilities have become more elaborate, allowing users to become more expressive in their IM exchanges. For example, most IM systems now allow users to send messages with selectable fonts and backgrounds.

IM services are offered by various portals, content providers and Internet Service Providers (ISPS) to their subscribers as part of a suite of subscriber services. Because of the popularity of IM systems, some ISPs have offered IM clients for free to users who do not subscribe to the ISP's Internet Services. These free IM clients allow any user with Internet access to exchange IMs with that service provider's subscribers and/or other internet users who have obtained the free IM client. This benefits current subscribers, who are thus able to exchange IMs with any of their friends, regardless of whether the friends are also subscribers. These free IM clients have a different look and feel from the full featured service, and offer a reduced set of features. Thus, they serve as an enticement for the users of the free IM clients to subscribe to the full suite of services offered by the ISP for a better IM experience.

Nevertheless, the free, reduced-feature IM clients are not solely used by non-subscribers. A subscriber who cannot access his or her own computer (for example, while traveling) can borrow a computer that already has the free IM client loaded on it, and dialog with his or her friends. Similarly, a subscriber who cannot access his or her own computer may download the free IM client to a computer having Internet Access (for example, at work), and use that computer to IM his or her friends. Because the free IM client has fewer features than the full paying interface, the paying subscriber may have a less satisfying IM experience whenever the subscriber cannot access his or her own computer, and instead uses a computer on which the free IM client is loaded.

A system is desired, which can deliver the improve IM experience of paying subscribers while away from their own computers.

### SUMMARY OF THE INVENTION

Some embodiments include a method for instant messaging, comprising: receiving a login request containing information associated with a user, determining, based on the information, whether that user is authorized to use at least one premium service for instant messaging, causing display of a premium instant messaging user interface enabling use of the premium service on a client computer if the user is authorized to use the premium service, and causing the same client computer to display a second instant messaging user interface in response to the login request if the user is not authorized to use the premium service for instant messaging.

Some embodiments include a method for instant messaging, comprising: receiving a message from a sender who is one of a plurality of users, the message having a recipient and containing a representation of premium content that is made available to a subset of the plurality of users, the subset including users who are authorized to send instant messages containing premium content, determining whether the sender is authorized to initiate an instant message containing the premium content, and transmitting the premium content to the recipient if the user is authorized to send instant messages containing the premium content, and performing an alternative step if the user is not authorized to send instant messages containing the premium content.

### BRIEF DESCRIPTION OF THE DRAWINGS

FIG. 1 is flow chart diagram of an exemplary login process according to one embodiment.

FIGS. 2 and 3 are flow chart diagrams showing an exemplary method for accessing premium multi-media content in an IM session.

FIG. 4 is a flow chart diagram showing secure control of delivery of the multi-media content in the IM session.

FIG. 5 is a flow chart diagram showing content caching in the client.

FIG. 6 is a flow chart diagram showing a method of control over displaying premium or customized status indicators in the friends list status field.

FIG. 7 is a flow chart diagram showing a method of control over user access to premium skins.

FIG. 8 is a block diagram of an exemplary system according to one embodiment.

FIG. 9 is a block diagram of the IM server shown in FIG. 8.

FIG. 10 is a block diagram of the client shown in FIG. 8.

FIG. 11 is an example of a display providing a means to access premium audibles.

FIG. 12A is an example of an IM panel in which a user can enter a shortcut for a premium status indicator.

FIG. 12B shows a portion of a friends list containing a premium status indicator

FIG. 13 shows an example of a premium skin for an IM interface.

### DETAILED DESCRIPTION

This description of the exemplary embodiments is intended to be read in connection with the accompanying drawings, which are to be considered part of the entire written description.

Embodiments are described below, in which premium IM service subscribers are provided access to premium IM services. Preferably, a single IM client application build can provide the premium IM services to the premium subscribers, and also provide basic IM services to users that do not subscribe to the premium services, without allowing the non-subscribers to access the premium IM services. In the description below, the interface that is made available to all users is referred to as the “second” or “basic IM interface.” In various embodiments, the second or basic IM interface may be made available for free, or at a reduced charge, to users who do not subscribe to the premium IM services and/or to users that do not subscribe to other services of the ISP. The premium IM service is available by subscription for a period of time, either as part of a full ISP subscription, or for a trial period, or for a separate fee, or as a promotional “gift” in exchange for the subscriber purchasing another product or service.

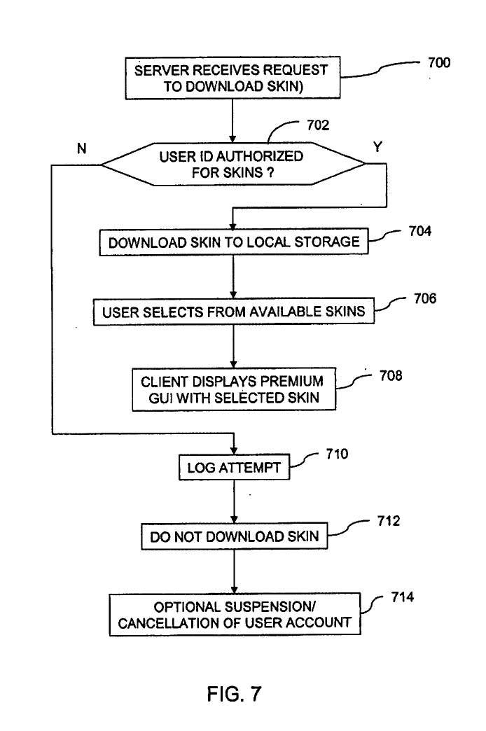

FIG. 8 is a block diagram of an exemplary system for instant messaging. A system includes a host 800 having at least one instant messaging (IM) server 802 and an associated storage device 804, such as a hard disk drive. In some embodiments, one or more separate content server computers 810, 820 are provided for transmitting premium content to a plurality of IM client computers 840, 850 by way of a network, which may be the Internet 830, a wide area network (WAN), a local area network (LAN) or other communications network. Premium content may include a type of audio/visual or animation object that is only available by a premium access subscription, and/or a specific piece of content that is only available to subscribers for use in IMs (e.g., a specific copyrighted image or audio/visual clip).

Although FIG. 8 only shows two content server computers 810 and 820 and two client computers 840 and 850, any number of content server hosts 810, 820 may be employed to eliminate Internet bottlenecks and improve content delivery speed. The audibles may be stored as 48×48 Flash files with sounds. For example, the content servers 810 and 820 may be part of a content distribution network and method operating according to U.S. Pat. Nos. 6,314,463 and 6,317,786 (both assigned to Yahoo! Inc.) or according to U.S. Pat. Nos. 6,421,726, 6,502,125 and 6,799,221 (all assigned to Akamai Technologies, Inc.), which are all incorporated by reference herein in their entireties. Also, although only two clients 840 and 850 are shown, any number of clients may be served. Data about the audibles, such as how they appear in a menu, may be stored on a staging server and pushed out to production servers.

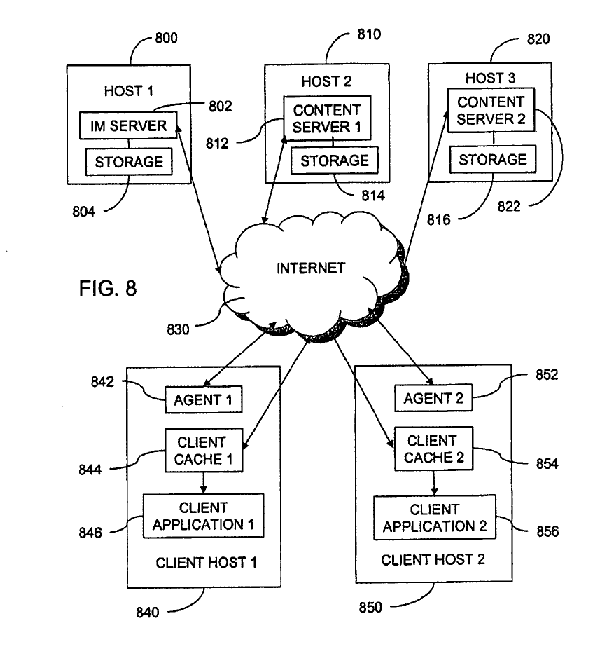

FIG. 9 is a block diagram showing some of the functions within the IM server 802. The IM server 802 runs as a program on the server host 800.

Server 802 comprises a means 900 for receiving a login request containing information associated with a user. This request contains a userid and authentication information such as a password, or a unique piece of information (e.g., the maiden name of the user's mother). The received data are compared to the authentication data stored in the user database in storage device 804. Upon successful entry of the authentication data, a user establishes an IM session, and can participate in one or more IM conversations with other users.

Means 902 are provided for determining, based on the login information, whether the current user is authorized to use at least one premium service for instant messaging. In some embodiments, a user database stores each user id, and a list of one or more premium services that the user is authorized to access. In some embodiments, premium services are made available to a user bundled together as a package. In other embodiments, individual premium services may be made available a la carte.

Means 904, 906 are provided in server 802 for causing display of a premium instant messaging user interface enabling use of the premium service on a client computer 840 if the user is authorized to use the premium service, and causing the same client computer 840 to display a second instant messaging user interface in response to the login request if the user is not authorized to use the premium service for instant messaging.

In some embodiments, a single client application 846 is capable of displaying either of two different IM graphical user interfaces (GUI's), the selection of the GUI being determined based on authorization information received from the server 802. For example the means in server 802 for causing display of the premium IM GUI or the second (free or basic) IM GUI in client host 840 may include a function 904 in the server 802 for generating a premium access token that is transmitted to the client 846.

In some embodiments, the premium access token includes at least the following data: the userid associated with the user, the list of services for which that user is authorized, and an expiration date. The client computer 840 displays the appropriate interface (premium interface or second (free) interface) as indicated by the premium access token. If the token includes an expiration date, and the same user logs into the same client computer again before the expiration date, the server need not generate another token during subsequent logins up until the expiration date. This reduces the token generation load on the server 802.

The length of time before expiration can be determined to strike a balance between security and performance. If a token is only good for a day or less, then the server 802 will spend a significant amount of computational resources in generating tokens. If the token is good for a full year, then a user may copy (i.e., steal) the decrypted token belonging to another user and reuse the decrypted token in another computer. An intermediate period of about a week may be more desirable.

In other embodiments (not shown), the token does not include an expiration date, but the token is only good for a single use, so that the server must generate, and the client must obtain, a new premium access token every time the user logs in to the IM system.

In other embodiments (not shown), only a single package of one or more premium IM services is available, so that instead of a list of permissions, the token can include a simple binary flag indicating whether or not the user is authorized for the single package of premium services.

In preferred embodiments, the server 802 further comprises a token encryption function that encrypts the premium access token using a private key of the server 802 and the public key of the client 846.

The IM server 802 further includes an IM content checking function 908 that checks IMs and download requests initiated from an IM client. In some embodiments, the content checking function 908 can also determine whether a request (by an IM client) that the server download premium content or transmit the premium content to another user (the recipient) was sent by a user authorized to initiate download or transmission of that premium content. The server 802 only permits such messages, downloads and transmissions if function 908 determines that the user is authorized for premium content access. In other embodiments, the content checking function 908 of server 802 may check peer-to-peer messages to determine whether an IM containing premium content as an attached or embedded object was sent by a user authorized to send that premium content.

IM Server 802 includes a basic service 910 for transmitting conventional IMs from one user to another. The IM transmitting service 910 is available to both users who are premium service subscribers and non-subscribers.

IM Server 802 includes a function 912 that takes action in response to a request for download of premium content. In preferred embodiments, the premium content is served by a content server (e.g., server 812), and the function 912 redirects the content requests to the content server (e.g., server 812). Redirection may be performed, for example, by server 802 transmitting a redirect message to an agent 852 of server 802 located in the recipient host 850. The agent 852 can then request a download of the premium content directly from the content server 812 or 822 to the recipient client 856. Alternatively, other redirection techniques may be used to cause the premium content to be transmitted from the content server 812 or 822 to the recipient client 856 (e.g., sending the redirect message to an agent 842 in the sender's host 840).

In other embodiments, a centralized IM server 802 stores the premium content in storage device 804, and the function 912 performs the download in response to a subscriber's request to download the premium content.

Referring again to FIG. 8, the clients 846 and 856 may be hosted on any computer platform(s) 840, 850 suitable for messaging applications. For example any multimedia PC with a processor operating at 233 MHz or faster may be used. In some embodiments, a version of the Windows Operating System by Microsoft Corporation of Redmond, Wash. is used, including a web browser having a Java virtual machine, such as Internet Explorer. In other embodiments, other platforms, such as the iMac computer by Apple Computer, Inc. of Cupertino, Calif., or a variety of UNIX based platforms may be used. Preferably, the browser of the clients includes a vector graphic animation plug in, such as Flash version 5.0.25 or later by Macromedia, Inc. of San Francisco, Calif.

In some embodiments, the clients 840, 850 may include a cache 844, 854 for premium content (e.g., premium animations with sound, referred to herein as “audibles”), to reduce server loading and network traffic due to transmission of premium content. The cache 844, 854 may be stored in any memory device, but server loading and network traffic reduction is best achieved if the cache 844, 854 resides in a non-volatile storage device, such as the hard disk drive of the client computer 840, 850. The client cache 844, 854 is not, however, required, and a client that does not have cache can still operate within the system.

In some embodiments, the cache 844 is used to store premium content (e.g., premium audibles) that is downloaded by the client 846 to be played (previewed) later by the user of that client computer 840. This avoids retransmission of the content if the sender of the premium content wishes to replay (preview) it later.

In other embodiments, the user's cache 844 may also be used to store a premium audible received by the user from another person (e.g., a friend using computer 850), and to replay the locally cached copy of the audible to the user when the same friend (or another party) requests transmission of that audible to the same user at client computer 840. For example, the IM server 802 may have an agent 842 operating on the host computer 840. When another user requests transmission of an audible to the client 840, the agent 842 determines whether that audible is already stored in the cache 844. If there is a cache hit, then the agent 842 instructs the client application 846 to retrieve the audible from the cache 844. If there is a cache miss, the agent 842 requests that the server 802 download the audible to cache 844 (which request may be fulfilled by redirecting the request to a content server 812 or 822), and the audible is then passed from the cache to the client application 846.

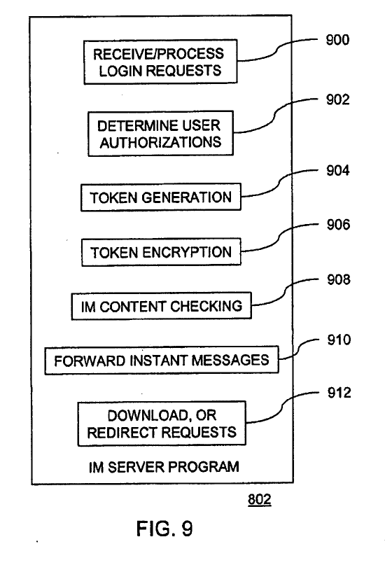

FIG. 10 is a detailed block diagram of the client application 842 shown in FIG. 8. In preferred embodiments, the client application 846 is a single build that can receive the premium access token from the server 802, and determine from the token what services to provide to the user that is currently logged on at that client 846. In some embodiments, the client 846 includes two or more GUIs, corresponding to the basic service and the premium service, and the client automatically provisions the appropriate interface and services to the current user.

In other embodiments, the client 846 includes a single GUI, in which all of the menus, buttons and controls are active when a premium service subscriber is logged on, but one or more of the menus, buttons or controls are inactive (grayed out) when a non-subscriber is logged on. In a variation of this single-interface type of embodiment, selection of any premium menu, button or control by a non-subscriber results in:

(1) display of an advertisement for the premium service, and/or

(2) a description of the function performed by that menu, button or control for premium service subscribers, and/or

(3) providing a link to (or displaying) a web page at which the user can immediately upgrade to the premium IM service.

Referring now to FIG. 10, client 846 provides the familiar instant messaging function 1000 available in typical instant messaging systems, including providing an area of the display in which the user can enter text and an area in which the text entered by both users in a given IM conversation is displayed. Thus, the IM function 1000 allows the user to send and receive IMs. An additional area displays the user's friends list and the status of each user on the list.

A decryption function 1002 is provided to decrypt the premium access token sent by the server. Preferably, the client 846 stores the token in a token database 1019 until the expiration date. During subsequent logins by the same user, up until the expiration date, the client does not need to obtain another premium access token from the server 802 until: (1) a different user logs on to this client computer, or (2) the expiration date, whichever comes first. Advantageously, if the token includes the userid, it is possible for the client 846 to store a respective token for each of a plurality of users in the token database 1019. The client 846 can immediately determine the authorizations for each of these users based on the stored token up until the expiration date, without obtaining a new premium access token for that user. The client 846 will deny the user access to the premium instant messaging user interface if a result of the decrypting step indicates that a premium access token has been altered after being sent from the server. This avoids the security risk that a hacker could use proxy tunneling to send a fake premium access token to a client to gain unauthorized access to the premium IM services. Without the private key of IM server 802, the hacker will be unable to generate a premium access token that looks proper after decryption using the public key.

The provisioning block 1004 determines which services to provide to the user, based on the list of services in the premium access token. All users are provided access to the suite of basic services 1010. The premium subscribers can also access the premium services 1020 in addition to the basic services 1010.

For example, in some embodiments, the basic services 1010 include the basic IM GUI 1012, the ability to send and receive IMs, the ability to receive and play (but not send) premium audibles, and the ability to display premium content (e.g., premium status emoticons of subscribers) but not the ability to have their own status indicator include premium status emoticons when viewed by friends in their friends list areas). In the same example, the premium services 1020 include a premium IM GUI 1022, a function 1024 to send specialized content, such as premium audibles, video, or the like in IMs, a function 1026 to use premium status indicators (that the subscriber's friends can view in the friends' “friends list” areas), and/or a function 1028 to download and display premium skins. These are only examples; various different suites of functions may be made available to the basic users, and various different suites of functions may be made available to the premium service subscribers. In addition, for any feature of the basic IM GUI, additional premium versions with improved functionality may be available.

For example, any button or control in the basic IM GUI may be replaced in the premium IM GUI by a customized button (in the shape of a selectable graphic). This customization may be implemented, for example, by allowing the premium user to select a graphic from a palate. Similarly, any content options (e.g., graphics, emoticons, sound clips, video clips, animations, avatars, etc.) in the basic IM GUI may be replaced in the premium IM service by an expanded set of content categories, sets and elements in the premium IM GUI.

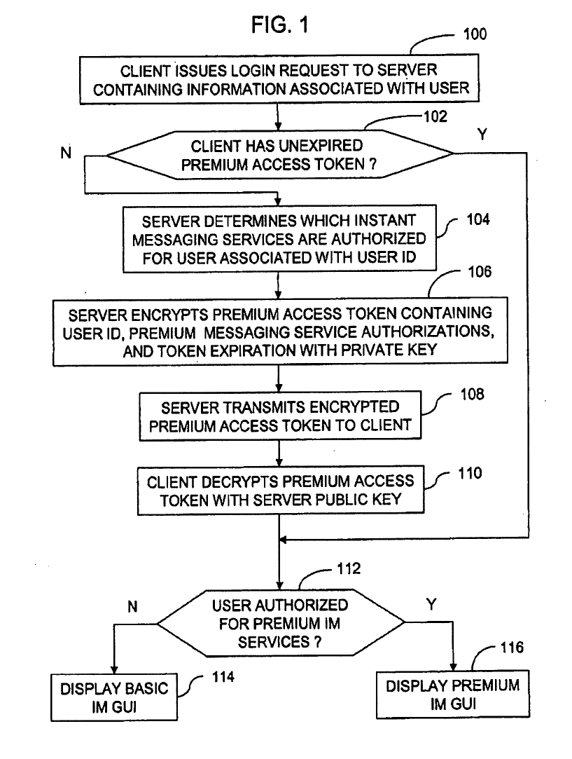

FIG. 1 is a flow chart diagram of an exemplary login procedure.

At step 100, a user logs into the IM system from the client computer 840 using a common log in screen, regardless of whether or not the user is a subscriber. The client application 846 issues a login request to the server 800. The login request contains information for uniquely identifying the user, such as a user id.

At step 102, the server determines whether the client has an unexpired premium access token for this userid. If the user has previously logged on from the same computer 840 and obtained a (currently unexpired) premium access token, the client application does not need to request or receive a new token at this time, and step 112 is performed next. If the user has not previously logged on from the same computer 840, or if a token was obtained but the most recent previously obtained a token has expired, then the user login communication with the server 800 may also include a request for a premium access token, and step 104 is executed next to perform token generation.

The login request from the client 846 to the server 802 should automatically result in the server transmitting a premium access token to the client if one is needed. In some embodiments, absent an indication that the client needs a new premium access token, the server does not issue a new token. In that case, at login, the client provides an indication when a token is needed. In other embodiments, the server 802 assumes that a premium access token is required at login and sends one, unless the client's login request indicates that the client already has an unexpired premium access token for this userid. In that case, the client provides an indication when a new token is not needed. In either of these variations, token generation computational resources expended by the server can be reduced by only sending a premium access token to the client when the client does not already have an unexpired token associated with the same userid.

At step 104, the server 802 determines, based on the userid, whether that user is authorized to use at least one premium service for instant messaging. The user's authorizations are stored in a database in storage device 804, and are associated with the user's user id, so the list of authorizations is readily obtained by a query to the database.

At step 106, the server 802 generates and encrypts a premium access token that includes data representing: a user identification associated with the user, a list of one or more premium services the user is authorized to access, and an expiration date. In some embodiments, the server 802 uses a private key to perform the encryption, and the client has a corresponding public key.

At step 108, the server 802 transmits the premium access token to the client computer 840.

At step 110, the client application 846 decrypts the premium access token using the public key of server 802. The client 846 stores the token in a token database 1019 (FIG. 10) in a local storage (e.g., a hard disk drive) device in client computer 840 that is accessible by the client application 846. Because an individual client computer 840 may be used by many different users during the course of a day or week, the client 846 saves all unexpired premium access tokens in the token database 1019. An unexpired premium access token for a given user is only marked invalid or overwritten in database 1019 if the user's authorization changes (either by subscribing to or unsubscribing from the premium services).

At step 112, the client 846 determines whether the user is authorized for premium IM services, based on the information in the premium access token. If the user is authorized to use the premium service for instant messaging, then at step 116, the client computer 840 displays a premium instant messaging user interface 1022 (FIG. 10) enabling use of the premium service. If the user is not authorized to use the premium service for instant messaging, then at step 114, the client computer 840 displays a second instant messaging user interface 1012 (FIG. 10) in response to the login request.

The method shown and described in FIG. 1 has the following effects:

(1) A given user can login to any computer having the IM client application 846, and the appropriate GUI (i.e., basic or premium) for that user is always displayed, regardless of what other users may have used the same computer. Thus, the user's interface is portable. When the server 802 receives a second login request containing the same userid information associated with the same user (the second login request originating at a different time and from a different computer than the first login request), the server 802 causes display of the premium IM GUI on the second computer if the user is authorized to use the premium IM service, and causes the second computer to display the second (basic) IM GUI in response to the second login request if the user is not authorized to use the premium IM service.

(2) A given computer running the IM client application 846 can automatically present the correct GUIs to all users, regardless of the sequence in which the users login to that computer. If a first non-subscriber logs in and logs out, followed by a first premium service subscriber logging in and logging out, followed by a second non-subscriber logging in and logging out, followed by a second premium service subscriber logging in, the client application 846 correctly displays the basic IM GUI, the premium IM GUI, the basic IM GUI, and the premium IM GUI, respectively, to those four users. Thus, a single client interface build can service both types of users.

Given these properties, the premium IM GUI can enhance the IM experience of subscribers, regardless of what computers they are using. Further, even though the client 846 capable of displaying the premium IM GUI 1022 is loaded on a given host 840, that host still displays the basic IM GUI 1012 whenever a non-subscriber logs into the system. The nonsubscribers do not get a “free ride” by virtue of sharing a computer with a premium IM service subscriber. Thus, the subscriber's IM experience is enhanced without removing the incentive for non-subscribers to upgrade to the premium service.

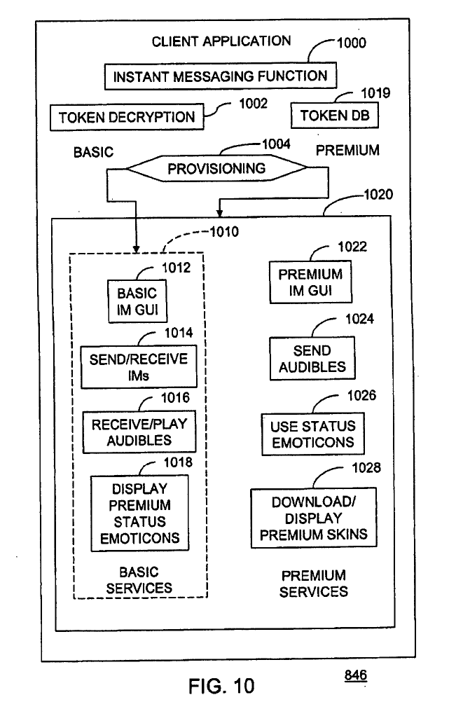

FIG. 11 is an example of one possible IM display including premium audibles. An IM window 1100 has a text entry field 1102, a conversation display field 1104, a control 1106 for activating the audible “bar” or field 1110, another control 1108 for accessing the premium graphics, a graphic or animation 1114 associated with the audible, and a text readout of the dialog in the audible. This is only one example. The appearance of the display and the controls used to access the premium audibles may vary considerably.

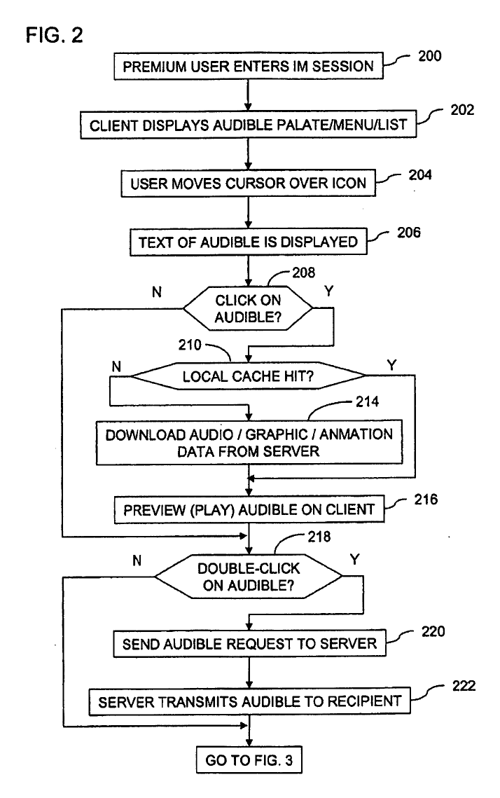

FIGS. 2 and 3 are flow chart diagrams showing an example of a portion of a premium service IM session, demonstrating an exemplary premium “audible” function. As noted above, in some embodiments, the entire “audible” function is only available to premium service subscribers. In other embodiments, the audibles function is available to all subscribers, but non-subscribers only have access to a small (“teaser”) subset of the audibles content. Reference is first made to FIG. 2.

At step 200 the premium user logs into IM server 802 and enters an IM session, using the process described above with reference to FIG. 1. The user can then begin an IM conversation with another user.

At step 202, the client 846 displays a palate, menu or list of premium audibles (animations with audio). In some embodiments, this information is continually displayed on a toolbar or area of the screen for the premium IM GUI. In other embodiments, this information is only displayed when the user takes some action (e.g., selecting a menu or a button on a toolbar). In some embodiments, only premium subscribers can display the audible palate, menu or list. In other embodiments, all users can display the audible palate, menu or list, but the premium subscribers see a larger, richer collection of audibles from which to choose.

At step 204, the user moves the cursor over an icon associated with one of the audibles (without clicking).

At step 206, text associated with the audible is displayed. In some embodiments, the text is a short title or caption. In other embodiments, the text is the speech uttered when the audible is played.

At step 208, if the user clicks on the icon associated with the audible, then step 210 is performed to allow the user to preview (play the animation/graphic and audio) the audible without sending it to any recipient. If the user does not click on the icon associated with the audible, then step 218 is performed.

At step 210, to preview the audible, the client application 846 requests the audible from client cache 844 if host 840 has cache, or from the IM server 802 if the client host 840 has no cache 844. If there is a cache hit (i.e., if the audible is already stored in the cache), then step 216 is performed without downloading the audible from the server. If there is a cache miss, then step 214 is performed.

At step 214, the audible (audio, plus animation or graphic) is downloaded from the content server 812 to the client cache 844. In other embodiments having a single centralized IM server (without a separate content server 812), the audible is downloaded from that centralized IM server to the cache 844.

At step 216, the copy of the audible in the client cache 844 is played for the user.

At step 218, if the user double-clicks on the icon associated with the audible, then step 220 is performed to allow the user to send the audible to a recipient with whom the user is currently engaged in an IM conversation. If the user does not double-click on the icon associated with the audible, then step 224 (FIG. 3) is performed.

At step 220, by double-clicking, the user initiates the transmission of the audible to the recipient. In some embodiments, to reduce network traffic and allow better control of access to the premium services, the audible is not transmitted peer-to-peer directly from the user client 846 to the recipient client (e.g., 856). Instead, the audibles can be stored in a content server, which can be different from, or the same as, the IM server 802. For better performance, it is preferred that at least one separate content server 812, 822 is provided. When the user double clicks on the audible icon, the client 846 sends a request to the server 802 for transmission of an audible to the IM recipient. The server 802 then redirects the request to the content server host 810 or 820.

At step 222, the content server 812 or 822 transmits the audible directly to the recipient on client computer 850. The audible is played in the recipient's IM session viewing window, as though the audible were sent as an embedded object from the user of client computer 840.

Referring now to FIG. 3, at step 224, if the user right clicks on the audible icon, step 226 is performed. Otherwise, step 242 is performed.

At step 226, a popup menu is displayed with options for preview, send or “find more like this.”

At step 228, if preview is selected, then step 230 is performed. Otherwise, step 232 is performed.

At step 230, step 210 (FIG. 2) is performed, as described above.

At step 232, if send is selected, then step 234 is performed. Otherwise, step 236 is performed.

At step 234, step 220 (FIG. 2) is performed as described above.

At step 236, if “find more like this” is selected, then step 238 is performed. Otherwise, step 242 is performed.

At step 238, the client 846 displays a browse window of audibles with the same category and set as the selected item. In systems having multiple audibles within some (or each) of the categories, the audibles within each category can be further divided into sets. Then the “find more like this” option will display all the items within the same set within the same category as the selected item that are available on the content server 810. For examples, an example of a category type is “movies,” with each set including clips or animation representations of a scene from a respectively different movie. For a category, “rock stars,” each set may include clips or animation representations of a portion of a respectively different song by the respective rock star to which that set corresponds.

In some embodiments, premium access users have access to premium content comprising additional categories and/or additional sets within categories and/or additional audibles within the sets, and the non-subscribers do not have access to this premium content. For example, non-subscribers may have access to 12 audibles, while subscribers have access to hundreds or thousands of audibles. Non-subscribers may have access to the categories, “movies,” and “rock stars,” while premium subscribers may have access to these plus “television shows,” “commercials,” “politicians,” “authors,” and the like.

At step 240, the user can add one of the icons displayed in step 238 to the list of audibles that are easily accessible to the user on client computer 840, and appear on a toolbar, menu or the like.

At step 242, the client computer is ready for repeating the sequence of steps for sending an audible, beginning at step 202.

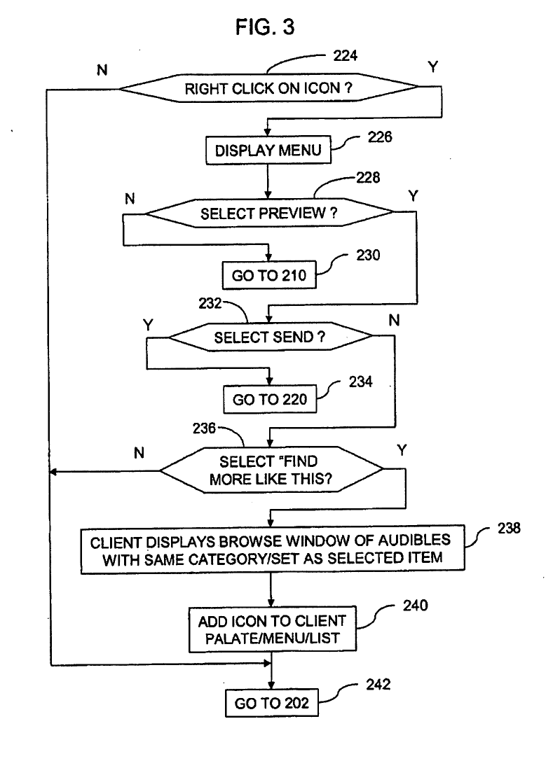

FIG. 4 is a flow chart diagram showing steps performed by the IM server 802 in handling the flow of IMs containing or requesting transmission of the premium content, in an embodiment where the client computer does not have a premium content cache. These steps are performed to prevent tampering that would allow an unauthorized user to access the premium services and/or the premium content. Thus, the system checks whether a user is authorized each time a user attempts to use an individual premium service (or access premium content), in addition to the initial check at login, which controls access to the premium IM GUI.

At step 400, the server 802 receives a request from the sending client 846 to transmit a premium audible to another user (e.g., client 856), such as a friend with whom the sending user is currently engaged in an IM conversation.

At step 402, the server 802 checks the premium service authorized user database, to determine whether the sending user is authorized to send the premium content. If the user is authorized, step 404 is performed. If the user is not authorized to initiate or send instant messages containing the premium content, the server 802 performs an alternative step beginning at step 410.

At step 404, if there is a separate content server 812, step 406 is performed. Otherwise, step 408 is performed.

At step 406, the IM server 802 redirects the sender's request to the content server 812, and step 408 is performed by the content server instead of by the IM server.

At step 408, the appropriate server (content server 812, if present, or IM server 802 in a centralized system having no separate content server) transmits the audible to the recipient, formatted so that the audible appears in the IM conversation window of the recipient as though directly sent peer-to-peer from the sender to the recipient.

At step 410, if the server 802 determines that the premium content is being sent by a user that is not authorized to use the premium services, the server 802 logs the attempt.

At step 412, neither the IM server 802 nor the content server 812 transmits the requested content to the recipient.

At step 414, the server 802 may optionally take one or more punitive steps, such as to terminate the sending user's current IM conversation, terminate the user's current IM session (including all conversations), suspension of the user's account or cancellation of the user's account.

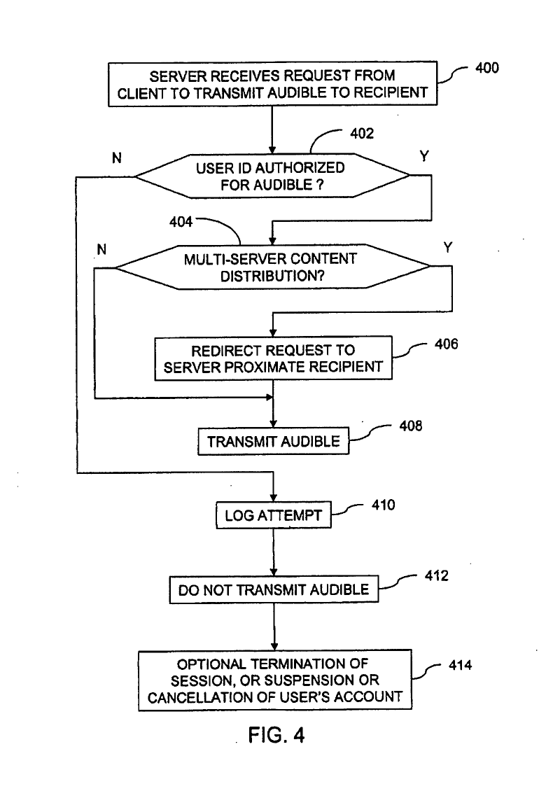

FIG. 5 shows a variation in which the server handles requests for audibles in a system having separate content servers and caching by the recipient client host 840.

At step 500, the IM server receives a request from a user (whom the server has previously confirmed is authorized for premium services) to transmit an audible to a recipient. For example, assume client 846 is the sender.

At step 502, the IM server 802 sends redirect information to an agent 852 of the server 812, where the agent 852 operates in the recipient host 850. The redirect information tells the agent 852 to request a download directly from the appropriate content server 812.

At step 504, the agent 852 requests the audible from the client cache 854 in the recipient host.

At step 506, if there is a cache hit (the audible is already stored in the cache 854), step 510 is performed. If there is a cache miss (the audible is not in the cache 854), step 508 is performed.

At step 508, the agent 852 downloads the audible from the content server 812 identified in the redirect message into the cache 854.

At step 510, the audible is transmitted from the local cache 854 to the recipient client application 856.

Note that an audible can be stored in the recipient client's cache 854, even if the recipient client is not authorized to send the audible in an IM. In the system as described above, double-clicking on an audible icon to transmit the audible does not send a peer-to-peer transmission, but instead results in a request to the IM server 802 (which may be redirected to a content server 812). Each time the IM server 802 receives a request to transmit an audible, the content server confirms that the requesting user is authorized before taking any action to satisfy or redirect the request. Thus, allowing caching of the audible in the recipient client cache 854 does not permit an unauthorized recipient to subsequently send that audible to another user in a peer-to-peer message. The caching does, however, allow the recipient 856 to replay the audible without repeating the download. Also, if the same audible is sent to the same recipient 856 by anyone (e.g., a third user) while that audible is still in the recipient's cache 854, a repeat of the download is not necessary.

Thus, having the IM server 812 process all audible transmission requests (instead of allowing peer-to-peer transmission) allows reduction in network and server loading, and at the same time facilitates enforcement of the subscription policy.

Further, the above described method allows subscribers to send the premium content to non-subscribers in IMs, without allowing the non-subscribers to do the same. This means that the subscribers perform an advertising function every time they send the premium content to a non-subscriber. Non-subscribers can be repeatedly exposed to highly desirable content that they can only send to other friends if they subscribe. This improves the likelihood that the non-subscribers become subscribers.

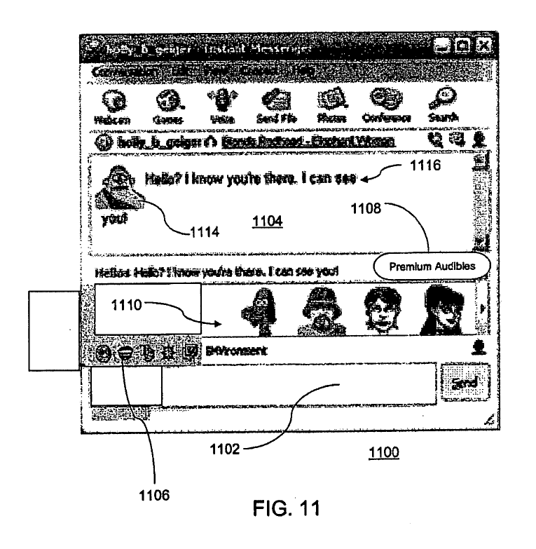

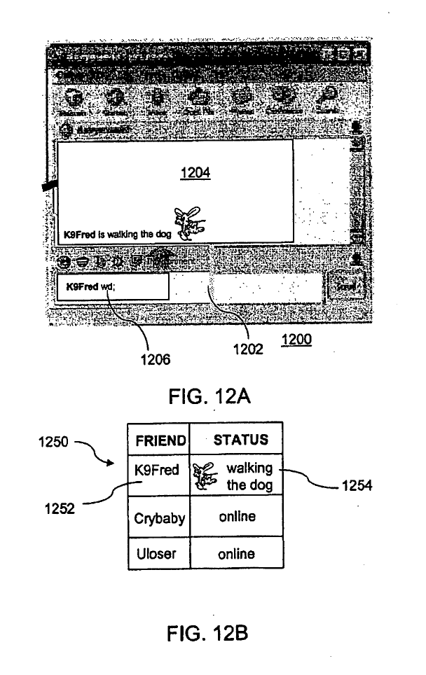

FIGS. 12A and 12B show one example of a premium status indicator field. In FIG. 12A, the user of IM interface 1200 inputs a shortcut (e.g., “wd;” in FIG. 12A). The conversation field 1204 may display the premium status graphic. FIG. 12B shows how the user's status indicator may appear in the friends list of another user who includes K9Fred on his or her friends list. This is only one example, and many different premium status indicators may be provided in a variety of interfaces, using a variety of looks and feels.

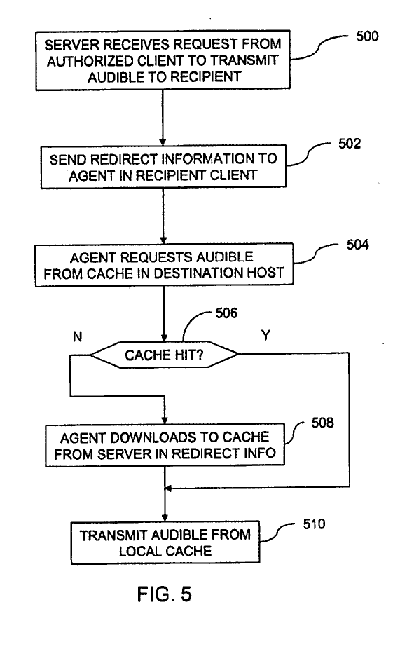

FIG. 6 is a flow chart diagram showing the handling of messages in an embodiment providing a premium subscriber with the ability to have custom or premium status indicators appear in conjunction with their userid in the “friends lists” of anyone who includes that subscriber in his or her friends list.

At step 600, the IM server 802 receives a status message from a sender (e.g., 846) containing premium content, indicating a change in the user's login status. (As used herein, a premium status indicator is a predetermined indicator provided by the system and available to premium subscribers.) For example, the user may have set his or her status (which appears in the status field of other users' friends lists) to a premium emoticon indicating that the user is “lovestruck.” In other embodiments (not shown), a premium subscriber may be permitted to provide his or her own custom status indicator, where the custom indicator was created or modified by the user, so that the user's status on other users' friends lists would include a custom status graphic indicating that the user is walking the dog.

At step 602, the server 802 determines whether this user is authorized to display the premium (or custom) status indicators on other users' friends lists. If the user is not authorized for premium (or custom) status indicators, the server 802 performs an alternative step beginning at step 606.

At step 604, for an authorized user, the IM server applies the premium (or customized) status. A status message is sent to all of the clients being operated by active users (e.g., 856) that include the sender user on their friends lists. Each of these client hosts (e.g., 850) will now display the premium (or custom) status in the friends list fields of their displays.

At step 606, for an unauthorized user, the unauthorized attempt to use the premium services is logged.

At step 608, the IM server 802 does not transmit a status message to the other clients, and the premium/customized status is not displayed in the other users' friends lists.

At step 610, the IM server may implement optional punitive measures, such as terminating the sender's IM session, or suspending or terminating the user's account for violating the terms of the user agreement.

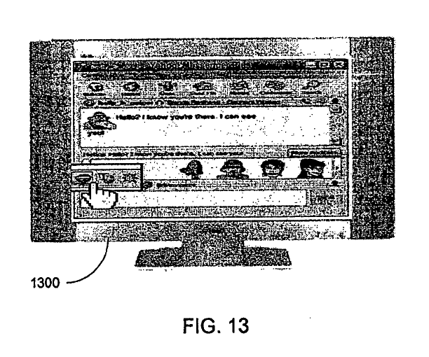

FIG. 13 shows one example of a possible premium skin 1300. In FIG. 13, the IM window retains its shape but is placed inside a graphic of a television set. In other embodiments, the shape of the IM window itself can be non-rectangular, and the location and shape of various fields and controls may differ.

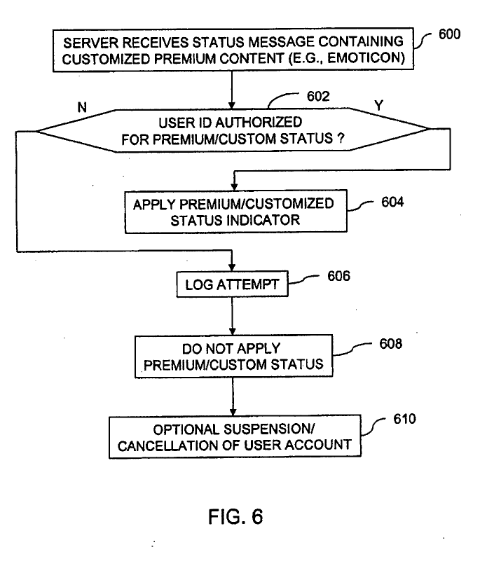

FIG. 7 is a flow chart diagram of an exemplary embodiment in which premium subscribers can download premium skins for their premium IM GUI. A skin is an element of the GUI that can be changed to alter the look of the interface without affecting its functionality. Skins can give an interface an entirely different look than what it originally came with. Skins are often used to change the look and feel of an application by altering the appearance and/or location of buttons, providing background images or borders that did not originally come with the application, changing the colors and/or other graphic elements, or even changing the shape of the window in which the application is displayed.

In some embodiments, the basic IM GUI 1012 provides only a single skin, and the premium subscriber IM GUI 1022 allows the user to select and download any of a collection of skins. In other embodiments, the basic IM GUI provides only a small number of skins, and the premium subscriber IM GUI provides a larger, more varied collection of skins and/or allows the subscriber to apply any of a predetermined set of modifications to some or all of the skins provided (e.g., change color, size or shape of individual fields). For example, the premium skins may include ones in which the IM window is shaped like a motorcycle, a racing car, a guitar, an airplane, a horse or other shape.

At step 700, the IM server 802 receives a request from a client 846 to download a skin.

At step 702, the IM server 802 checks the premium IM service authorization database and determines whether that user is authorized to download skins. If the user is authorized, step 704 is performed. If the user is not authorized to initiate or send instant messages containing the premium content, the server 802 performs an alternative step beginning at step 710.

At step 704, the authorized user downloads one or more skins to a local storage device, such as the user's hard drive. In some embodiments, the download files are compressed. Preferably, the user is instructed to store the downloaded skin(s) in the same folder or directory where the current skin is located.

At step 706, the user uses a menu to select one of the locally stored skins, which is immediately applied.

At step 708, the client computer 840 displays the premium GUI with the selected skin.

At step 710, if the user is not authorized to download skins, the attempt is logged.

At step 712, the IM server 802 does not download the requested skin to the client 840.

At step 714, the IM server 802 may take a punitive measure, such as terminating the sender's IM session, or suspending or terminating the user's account for violating the terms of the user agreement.

Examples are described above of three functions, to which access can be reserved for premium IM service subscribers, or if all users have access to the function, then subscribers can be given enhanced options and/or a larger number of options from which to select. These are only meant to serve as examples, and the suite of premium services may include other services and/or content that differentiates the subscription service from the non-subscription service.

For example, the premium content may include premium avatars. An avatar is a graphical icon that represents the user, and is observed by the other party to an IM conversation. The IM GUI may allow the user to choose from a number of fanciful avatars. The avatars may change appearance in response to certain user actions, e.g., when the user sends an emoticon in an IM. The premium content may include a larger variety of avatars and/or may include more sophisticated avatars, which may include three-dimensional graphics or enhanced animations.

Other types of premium content are contemplated. For example, these may include but are not limited to: the ability to create personal interactive backgrounds (IMVironments) the ability to store a message archive on the server so the premium IM service subscriber can access it from anywhere, the ability to enable encryption for messages, and/or the ability to communicate with users on other IM platforms.

The method described above provides a measure of control for premium service access, using both the client application as well as the server application to implement these controls. The above method is simplified when used for controlling access to data and/or objects that do not involve peer-to-peer transmissions. The use of premium status indicators and premium skin downloads are naturally achieved by exchanges between the client and server. The handling of premium audibles is an example of a transmission that could be implemented either as client-to-server (as described above) or peer-to-peer. The above described client-to-server implementation simplifies security and access control relative to a peer-to-peer approach, because the server “knows” what the client is attempting to do, without requiring the server to analyze attachments or embedded objects within instant messages. The client makes a direct request to the IM server, requesting that the server transmit an audible on behalf of the sender, to appear within the current IM window.

Further, although an example is provided in which the premium audibles, premium status indicators and premium skins are all bundled together in a single offering, the premium services may be unbundled and offered a la carte. By using a premium access token that includes a list of the authorizations for individual premium services, the same method described above can be used regardless of whether or not the premium services are bundled.

In some embodiments, the user directly pays for the premium IM services as a service purchase, not bundled with any other paid ISP services. In other embodiments, the premium IM service may be provided to users of the ISP's networking services. In some embodiments, the premium IM service may be provided to non-subscribers on a trial basis for a limited time. In still other embodiments, access to the premium IM services may be provided by an affiliate or partner of the IDS, as an inducement for the user to purchase the affiliate's products or services.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, ZIP™ disks, external flash memory, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for instant messaging, comprising:
receiving a login request containing information associated with a user;
determining, based on the information, whether that user is authorized to use at least one premium service for instant messaging;
causing display of a premium instant messaging user interface enabling use of the premium service on a client computer in response to the user is authorized to use the premium service, and causing the same client computer to display a second instant messaging user interface in response to the user is not authorized to use the premium service for instant messaging.

2. The method of claim 1, wherein the premium service enables initiating an instant message containing at least an item selected from the group consisting of audible sound files, images, and animations.

3. The method of claim 2, further comprising:
storing the instant message in a server;
receiving a request via the premium instant messaging user interface in the client computer to transmit the instant message to a recipient; and
transmitting the instant message from the server to the recipient.

4. The method of claim 1, wherein the premium service includes selecting a skin from a set of skins.

5. The method of claim 4, further comprising:
storing descriptions of the set of skins;
receiving a request from the client computer to download a selected skin; and
transmitting information defining the selected skin to the client computer.

6. The method of claim 1, wherein the premium service includes displaying an emoticon in a status indicator associated with the user.

7. The method of claim 1, wherein the causing display of a premium instant messaging user interface comprises:
encrypting a premium access token; and
transmitting the premium access token to the client computer.

8. The method of claim 7, wherein the premium access token includes data representing: a user identification associated with the user, a list of one or more premium services the user is authorized to access, and an expiration date.

9. The method of claim 1, further comprising:
receiving a second login request containing the same information associated with the same user, the second login request originating at a different time and from a different computer than the first login request; and
causing display of the premium instant messaging user interface on the second computer in response to the user is authorized to use the premium service, and causing the second computer to display the second instant messaging user interface in response to the second login request in response to the user is not authorized to use the premium service for instant messaging.

10. A method for instant messaging, comprising:
receiving a message from a sender who is one of a plurality of users, the message having a recipient and containing a representation of premium content that is made available to a subset of the plurality of users, the subset including users who are authorized to send instant messages containing premium content;
determining whether the sender is authorized to initiate an instant message containing the premium content; and
transmitting the premium content to the recipient in response to the sender is authorized to send instant messages containing the premium content, and performing an alternative step in response to the sender is not authorized to send instant messages containing the premium content.

11. The method of claim 10, wherein the alternative step comprises preventing delivery of the message.

12. The method of claim 10, wherein the alternative step comprises suspending a messaging conversation, a messaging session or a messaging account used by the sender to send the message containing premium content.

13. The method of claim 10, wherein the premium content is cached at a computer used by the sender; and wherein the premium content is previewed by the sender.

14. The method of claim 10, wherein the transmitting is performed by a server computer in response to the message from the sender.

15. The method of claim 10, wherein:
the receiving and determining are performed by a first server computer, and the transmitting is performed by at least a second server computer.

16. The method of claim 10, wherein the premium content is cached at a computer used by the recipient for replaying the premium content.

17. A method for instant messaging, comprising:
transmitting a login request containing information associated with a user to a server;
receiving an access token from the server containing information identifying whether the user is authorized to use at least one premium service for instant messaging; and
displaying a premium instant messaging user interface enabling use of the premium service in response to the user is authorized to use the premium service, and displaying a second instant messaging user interface in response to the user is not authorized to use the premium service for instant messaging.

18. The method of claim 17, wherein the premium instant messaging user interface enables the user to send or receive an instant message containing at least an item selected from the group consisting of audible sound files, images, and animations, and wherein the second instant messaging user interface enables the user to receive the instant message containing at least an item selected from the group consisting of audible sound files, images, and animations.

19. The method of claim 18, further comprising:
decrypting the access token; and
denying the user access to the premium instant messaging user interface in response to a result of the decrypting indicates that the access token has been altered after being sent from the server.

20. The method of claim 18, further comprising:
caching the instant message in a local client computer; and
replaying the instant message in the local client computer without retransmitting the instant message from the server to the local client computer.

21. The method of claim 18, wherein the premium instant messaging user interface has a skin and enables the user to select and download the skin from a set of skins stored on the server.

22. A computer program product for instant messaging, comprising a medium storing executable program code, the computer program product comprising:
code for receiving a login request containing information associated with a user;
code for determining, based on the information, whether that user is authorized to use at least one premium service for instant messaging; and
code for causing display of a premium instant messaging user interface enabling use of the premium service on a client computer in response to the user is authorized to use the premium service, and causing the same client computer to display a second instant messaging user interface in response to the user is not authorized to use the premium service for instant messaging.

23. The computer program product of claim 22, wherein the premium service enables initiating an instant message containing at least an item selected from the group consisting of audible sound files, images, and animations.

24. The computer program product of claim 23, further comprising:
code for storing the instant message in a server;
code for receiving a request via the premium instant messaging user interface in the client computer to transmit the instant message to a recipient; and
code for transmitting the instant message from the server to the recipient.

25. The computer program product of claim 22, wherein the premium service includes selecting a skin from a set of skins.

26. The computer program product of claim 25, further comprising:
code for storing descriptions of the set of skins;
code for receiving a request from the client computer to download a selected skin; and
code for transmitting information defining the selected skin to the client computer.

27. The computer program product of claim 22, wherein the premium service includes displaying an emoticon in a status indicator associated with the user.

28. The computer program product of claim 22, wherein the code for causing display of a premium instant messaging user interface comprises:
code for encrypting a premium access token; and
code for transmitting the premium access token to the client computer.

29. The computer program product of claim 28, wherein the premium access token includes data representing: a user identification associated with the user, a list of one or more premium services the user is authorized to access, and an expiration date.

30. The computer program product of claim 22, further comprising:
code for receiving a second login request containing the same information associated with the same user, the second login request originating at a different time and from a different computer than the first login request; and
code for causing display of the premium instant messaging user interface on the second computer in response to the user is authorized to use the premium service, and causing the second computer to display the second instant messaging user interface in response to the second login request in response to the user is not authorized to use the premium service for instant messaging.

31. A computer program product for instant messaging, comprising a medium storing executable program code, the computer program product comprising:
code for receiving a message from a sender who is one of a plurality of users, the message having a recipient and containing a representation of premium content that is made available to a subset of the plurality of users, the subset including users who are authorized to send instant messages containing premium content;
code for determining whether the sender is authorized to initiate an instant message containing the premium content; and
code for transmitting the premium content to the recipient in response to the sender is authorized to send instant messages containing the premium content, and code for performing an alternative step in response to the sender is not authorized to send instant messages containing the premium content.

32. The computer program product of claim 31, wherein the code for performing the alternative step comprises code for preventing delivery of the message.

33. The computer program product of claim 31, wherein the code for performing the alternative step comprises code for suspending a messaging conversation, a messaging session or a messaging account used by the sender to send the message containing premium content.

34. The computer program product of claim 31, wherein the premium content is cached at a computer used by the sender; and wherein the premium content is previewed by the sender.

35. The computer program product of claim 31, wherein the code for transmitting is executed by a server computer in response to the message from the sender.

36. The computer program product of claim 31, wherein:
the code for receiving and code for determining are executed by a first server computer, and
the code for transmitting is executed by at least a second server computer.

37. The computer program product of claim 31, wherein the premium content is cached at a computer used by the recipient for replaying the premium content.

38. A system for instant messaging, comprising:
an instant messaging server comprising a data storage, the instant messaging server further comprising
logic for receiving a message from a sender who is one of a plurality of users, the message having a recipient and containing a representation of premium content that is made available to a subset of the plurality of users, the subset including users who are authorized to send instant messages containing premium content;
logic for determining whether the sender is authorized to initiate an instant message containing the premium content; and
a content server comprising a data storage, the content server further comprising logic for transmitting the premium content to the recipient in response to the sender is authorized to send instant messages containing the premium content, and logic for performing an alternative step in response to the sender is not authorized to send instant messages containing the premium content.

39. The system of claim 38, wherein the logic for performing the alternative step comprises logic for preventing delivery of the message.

40. The system of claim 38, wherein the logic for performing the alternative step comprises logic for suspending a messaging conversation, a messaging session or a messaging account used by the sender to send the message containing premium content.

41. The system of claim 38, wherein the premium content is cached at a computer used by the sender; and wherein the premium content is previewed by the sender.

42. The system of claim 38, wherein the logic for transmitting is performed by the content server in response to the message from the sender.

43. The system of claim 38, wherein:
the logic for receiving and logic for determining are performed by the instant messaging server, and
the logic for transmitting is performed by the content server.

44. The system of claim 38, wherein the premium content is cached at a computer used by the recipient for replaying the premium content.
